(19) United States
(12) Patent Application Publication
(10) Pub. No.: US 2017/0098352 A1
(43) Pub. Date: Apr. 6, 2017

(54) SYSTEM AND METHOD OF PROVIDING INTELLIGENT SYSTEM TROUBLE NOTIFICATIONS USING LOCALIZATION

(71) Applicant: Honeywell International Inc., Morristown, NJ (US)

(72) Inventors: Shaiju Janardhanan, Bangalore (IN); Hemanth PV, Bangalore (IN)

(21) Appl. No.: 14/872,715

(22) Filed: Oct. 1, 2015

(51) Int. Cl. G08B 13/12; G08B 29/08

(52) U.S. Cl. CPC G08B 13/12; G08B 29/08

(57) ABSTRACT

Systems and methods of providing intelligent system trouble notifications using localization are provided. Some methods can include a dealer device receiving a first signal from a first control panel device indicative of a system trouble event at the first control panel device, the dealer device transmitting a second signal to each of a plurality of other control panel devices soliciting a status update therefrom, the dealer device receiving a third signal from each of the plurality of other control panel devices indicative of a respective system status, and the dealer device determining whether the system trouble event is local to the first control panel device or is area wide.

### FIELD

The present invention relates generally to security systems and methods. More particularly, the present invention relates to a system and method of providing intelligent system trouble notifications using localization.

### BACKGROUND

Known security systems include a control panel device that monitors a region in which it is installed and transmits alert signals and notifications to a central monitoring station regarding any trouble or alarm event. When user notifications are enabled, a control panel device can also transmit alert signals and notifications to a user device, for example, a mobile telephone.

When system trouble occurs, such as a power or communication failure, a user and a central monitoring station can receive a signal from a control panel device with a system trouble alert. The system trouble can be limited to the user's monitored premises or be spread across an entire region or area, for example, an area wide power outage. However, regardless of the type of system trouble, the user and the central monitoring station receive the same type of system trouble alert and therefore, have no way to distinguish between a system trouble limited to the user's premises and an area side system trouble.

Indeed, when a system trouble alert is limited to a user's monitored premises, there is a need for a user to be extra alert and proactive because the trouble may be due to a burglar or other unauthorized intruder cutting the power supply to the premises. However, known systems and methods provide no way for a user to identify such an event.

Moreover, when a system trouble alert is area wide, many control panel devices throughout the area might transmit a system trouble alert or notification signal to the central monitoring station, thereby overloading the network. Such area wide power and communication failures are rampant in developing nations so overloading networks is of high concern.

In view of the above, there is a continuing, ongoing need for improved systems and methods.

### BRIEF DESCRIPTION OF THE DRAWINGS

FIG. 1 is a flow diagram of a method in accordance with disclosed embodiments; and

FIG. 2 is a block diagram of a dealer device in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a system and method of providing intelligent system trouble notifications using localization. For example, systems and methods disclosed herein can distinguish between system trouble limited to a user's monitored premises and system trouble spread across an entire region or area.

The systems and methods disclosed herein are described in connection with system trouble that includes power and communication outages. However, it is to be understood that systems and methods disclosed herein are not so limited and can also be used in connection with control panel devices detecting other types of system trouble or facility breakdowns, such as water supply breakdowns.

In accordance with disclosed embodiments, when a system trouble event occurs at a control panel device, such as a power or communication failure, systems and methods disclosed herein can confirm whether other control panel devices within a predetermined area are experiencing the same system trouble event. For example, a dealer device can execute a software application in accordance with disclosed embodiments and can support or service a plurality of control panel devices. When a system trouble event occurs at a first control panel device, the first control panel device can transmit a request signal to the dealer device. Upon receiving the request signal, the dealer device can transmit a corresponding status request signal to a plurality of other control panel devices, including control panel devices that are supported or serviced by the dealer device and are within a predetermined area, for example, within the same area code or zip code as the first control panel device. Indeed, in some embodiments, the dealer device can include a database of control panel devices supported by the dealer device and their corresponding area codes or zip codes. In some embodiments, the dealer device can transmit signals, alerts, or notifications to all control panel devices within a predetermined area of the dealer device, and in some embodiments, the dealer device can reply to all request signals received from a control panel device, thereby increasing the reliability of systems and methods disclosed herein.

Responsive to the status request signal transmitted by the dealer device, each of the plurality of other control panel devices can transmit a status signal to the dealer device. Based on the received status signals, the dealer device can determine whether the system trouble event is limited to the premises of the first control panel device or is area wide.

Indeed, if the dealer device receives a status signal from one or more control panel devices indicating system trouble, then the dealer device can determine that the system trouble is area wide and notify the first control panel device accordingly. Based upon such a notification, the first control panel device can transmit an alert signal to a user device indicative of the area wide trouble, display a trouble signal locally, and, depending on network traffic concerns, may or may not transmit an alert signal to a central monitoring station. When the first control panel device does not transmit an alert signal to the central monitoring station to notify the central monitoring station about area wide system trouble, the number of notifications sent to a central monitoring station can be reduced.

Conversely, if the dealer device receives a status signal from all other control panel devices in the plurality of control panel devices indicating no system trouble, then the dealer device can determine that the system trouble is limited to the premises of the first control panel device and notify the first control panel device accordingly. Based on such a notification, the first control panel device can transmit an alert signal to both a user device and a central monitoring station advising of the localized system trouble. Accordingly, a user can be alerted to be extra cautious and take the necessary and precautionary steps and measures to remove the localized system trouble.

In some embodiments, the control panel devices and the dealer device described herein can communicate via a communication path that is different than a communication path via which the control panel devices communicates with other devices. For example, a control panel device can communicate with a user device or a central monitoring station via a telephone line and can communicate with the dealer device via a GSM based communication network. Accordingly, even when a fixed telephone line to a user's home is cut, a control panel device at the user's home can confirm with the dealer device that the system trouble is localized, instead of assuming that it is area wide system trouble. Once the user confirms localized system trouble, he can inspect his home premises to identify possible reasons for the trouble.

In some embodiments, the control panel devices can communicate with the dealer device via a secured communication channel. In these embodiments, requests and signals from a control panel device will only be recognized by a dealer device with which the control panel device is registered. Similarly, in these embodiments, the dealer device can transmit requests and signals to only control panel devices registered with the dealer device and identified by the dealer device as being in the same area as a requesting control panel device.

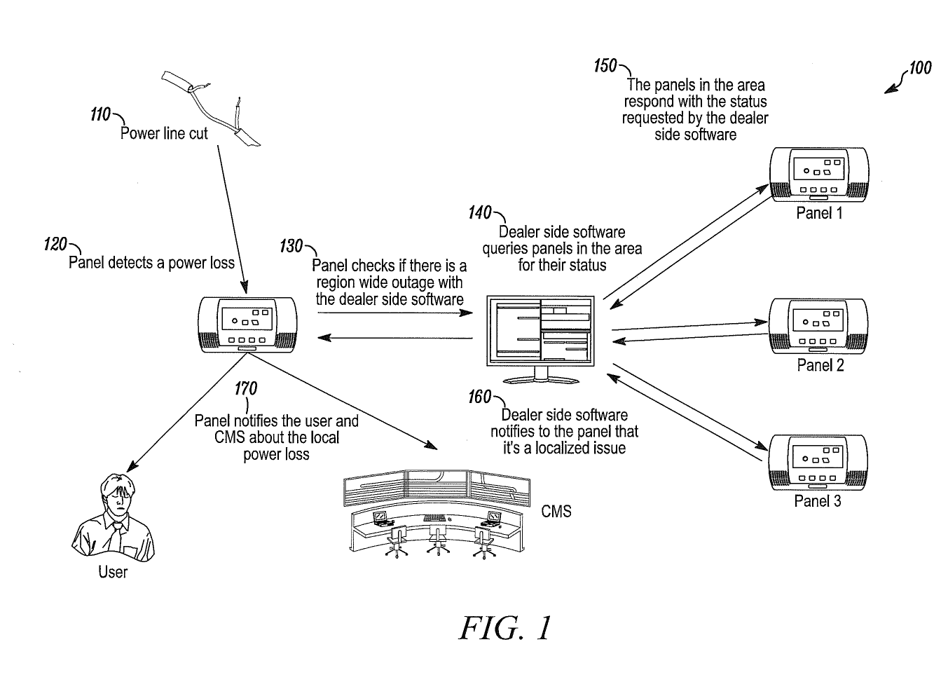

FIG. 1 is a flow diagram of a method 100 in accordance with disclosed embodiments. As seen in FIG. 1, the method 100 can include a power line to a first control panel device being cut by a burglar or other unauthorized intruder as in 110 and the first control panel device detecting the power loss as in 120. Upon detecting the power loss as in 120, the first control panel device can transmit a signal to a dealer device as in 130 to determine whether the power loss is local to the first control panel device or is area wide.

Upon receipt of the signal from the first control panel device as in 130, the dealer device can transmit a signal to a plurality of control panel devices (Panels 1, 2, 3) within a predetermined area of the first control panel device as in 140 requesting the status of each of the plurality of control panel devices. For example, the dealer device can identify the area code of the first control panel device from an internal database device and identify the plurality of control panel devices as all other control panel devices in the identified area code. In some embodiments, the dealer device can transmit a signal to only a fixed number of other control panel devices in the identified area code.

Upon receiving the signal from the dealer device as in 140, each of the plurality of control panel devices can transmit a signal to the dealer device as in 150 advising the dealer device of its respective status. Responsive thereto, the dealer device can analyze the signals from each of the plurality of control panel devices to determine whether the power loss at the first control panel device is local to the first control panel device or is area wide. For example, if another control panel device in the plurality of control panel devices reported a power loss to the dealer device, then the dealer device can determine that the power loss issue is area wide. However, if no other control panel device in the plurality of control panel devices reported a power loss to the dealer device, then the dealer device can determine that the power loss issue is local to the first control panel device.

As seen in FIG. 1, when the dealer device determines that the power loss issue is local to the first control panel device, the dealer device can transmit a signal to the first control panel device as 160 notifying the first control panel device that the power loss issue is a localized issue. Upon receipt of the signal from the dealer device as in 160, the first control panel device can transmit a signal to a user device and to a central monitoring station as in 170 notifying the user and the central monitoring station about the local power loss.

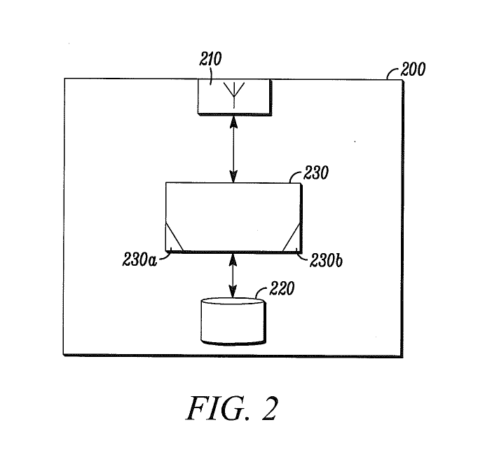

FIG. 2 is a block diagram of a dealer device 200 in accordance with disclosed embodiments. As seen in FIG. 2, the dealer device 200 can include a wireless transceiver 210, a memory device 220, control circuitry 230, one or more programmable processors 230a, and executable control software 230b as would be understood by one of ordinary skill in the art. The executable control software 230b can be stored on a transitory or non-transitory computer readable medium, including, but not limited to, local computer memory, RAM, optical storage media, magnetic storage media, flash memory, and the like. In some embodiments, the control circuitry 230, programmable processors 230a, and control software 230b can execute and control the methods as described above and herein.

The wireless transceiver 210 can communicate with control panel devices as described above, and the memory device 220 can store a database of control panel devices and their associated area codes, zip codes, or the like. The control circuitry 230, programmable processors 230a, and control software 230b can instruct the transceiver 210 to transmit signals as described above and can process received request signals and status signals to determine whether identified system trouble is local to a particular control panel device or area wide.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
a dealer device receiving a first signal from a first control panel device indicative of a system trouble event at the first control panel device;
the dealer device transmitting a second signal to each of a plurality of other control panel devices soliciting a status update therefrom;
the dealer device receiving a third signal from each of the plurality of other control panel devices indicative of a respective system status; and
the dealer device determining whether the system trouble event is local to the first control panel device or is area wide.

2. The method of claim 1 further comprising the dealer device identifying each of the plurality of other control panel devices as control panel devices within a predetermined area of the first control panel device.

3. The method of claim 2 further comprising:
the dealer device identifying, from an internal database device, an area code of the first control panel device; and
the dealer device identifying, from the internal database device, each of the plurality of other control panel devices as having the area code of the first control panel device.

4. The method of claim 2 further comprising identifying each of the plurality of other control panel devices as control panel devices supported by the dealer device.

5. The method of claim 1 further comprising the dealer device determining that the system trouble event is local to the first control panel device when none of the third signals received from each of the plurality of other control panel devices is indicative of a respective system trouble event.

6. The method of claim 1 further comprising the dealer device determining that the system trouble event is area wide when at least one of the third signals received from each of the plurality of other control panel devices is indicative of a respective system trouble event.

7. The method of claim 1 further comprising the dealer device determining that the system trouble event is area wide when at least a predetermined number of the third signals received from each of the plurality of other control panel devices is indicative of a respective system trouble event.

8. The method of claim 1 further comprising the dealer device transmitting a fourth signal to the first control panel device indicative of localized or area wide system trouble.

9. The method of claim 8 wherein, when the fourth signal is indicative of area wide system trouble, the fourth signal includes instructions for the first control panel device to refrain from notifying a central monitoring station of the area wide system trouble, and wherein, when the fourth signal is indicative of localized system trouble, the fourth signal includes instructions for the first control panel device to transmit a fifth signal to a user device to notify a user about the localized system trouble.

10. The method of claim 1 wherein the dealer device communicates with the first control panel device via a first communication network that is different than communication networks via which the first control panel devices communicates with other devices.

11. A system comprising:
a transceiver;
a programmable processor; and
executable control software stored on a non-transitory computer readable medium,
wherein the transceiver receives a first signal from a first control panel device indicative of a system trouble event at the first control panel device,
wherein the transceiver transmits a second signal to each of a plurality of other control panel devices soliciting a status update therefrom,
wherein the transceiver receives a third signal from each of the plurality of other control panel devices indicative of a respective system status, and
wherein the programmable processor and the executable control software determine whether the system trouble event is local to the first control panel device or is area wide.

12. The system of claim 11 wherein the programmable processor and the executable control software identify each of the plurality of other control panel devices as control panel devices within a predetermined area of the first control panel device.

13. The system of claim 12 further comprising a database device, wherein the programmable processor and the executable control software identify, from the database device, an area code of the first control panel device, and wherein the programmable processor and the executable control software identify, from the database device, each of the plurality of other control panel devices as having the area code of the first control panel device.

14. The system of claim 12 wherein the programmable processor and the executable control software identify each of the plurality of other control panel devices as being serviced thereby.

15. The system of claim 11 wherein the programmable processor and the executable control software determine that the system trouble event is local to the first control panel device when none of the third signals received from each of the plurality of other control panel devices is indicative of a respective system trouble event.

16. The system of claim 11 wherein the programmable processor and the executable control software determine that the system trouble event is area wide when at least one of the third signals received from each of the plurality of other control panel devices is indicative of a respective system trouble event.

17. The system of claim 11 wherein the programmable processor and the executable control software determine that the system trouble event is area wide when at least a predetermined number of the third signals received from each of the plurality of other control panel devices is indicative of a respective system trouble event.

18. The system of claim 11 wherein the transceiver transmits a fourth signal to the first control panel device indicative of localized or area wide system trouble.

19. The method of claim 8 wherein, when the fourth signal is indicative of area wide system trouble, the fourth signal includes instructions for the first control panel device to refrain from notifying a central monitoring station of the area wide system trouble, and wherein, when the fourth signal is indicative of localized system trouble, the fourth signal includes instructions for the first control panel device to transmit a fifth signal to a user device to notify a user about the localized system trouble.

20. A system comprising:
a first control panel device;
a dealer device; and
a plurality of other control panel devices,
wherein the first control panel devices transmits a first signal to the dealer device indicative of a system trouble event at the first control panel device,
wherein, the dealer device identifies each of the plurality of other control panel devices as being within a predetermined area of the first control panel device and transmits a second signal to each of the plurality of other control panel devices soliciting a status update therefrom,
wherein each of the plurality of other control panel devices transmits a third signal to the dealer device indicative of a respective system status, and
wherein, based on the third signals, the dealer device determines whether the system trouble event is local to the first control panel device or is area wide.
